(19) United States
(12) Patent Application Publication
(10) Pub. No.: US 2026/0220660 A1
(43) Pub. Date: Jul. 30, 2026

(54) MANAGEMENT AUTOMATION USING DATABASE SIGNALS

(71) Applicant: Salesforce, Inc., San Francisco, CA (US)

(72) Inventors: Tarundeep Batra, San Francisco, CA (US); Nikhil Kapre, Bangalore (IN)

(21) Appl. No.: 19/041,368

(22) Filed: Jan. 30, 2025

(51) Int. Cl. G06Q 30/0207; G06Q 30/0601

(52) U.S. Cl. CPC G06Q 30/0224; G06Q 30/0239; G06Q 30/0631

(57) ABSTRACT

Systems, devices, and techniques are disclosed for management automation using database signals. An API call requesting actionable signals may be sent to a service of a database. An API response including the actionable signals may be received. The actionable signals may include indications of a subject and are generated from performance metrics generated from data stored in the database. Subjects may be selected from the actionable signals. An API call including the selected subjects may be sent to a generative system. Generated items based on the selected subjects may be received from the generative system. The subjects may include products or product categories sold by an online store. The generated items may include promotions for the products of the selected subjects.

### BACKGROUND

Merchants can use data collected for their online stores to determine actions they can take to maintain and improve their online stores and increase performance. Merchants may need to spend large amounts of time analyzing data to determine which actions to take and then actually performing these actions. A merchant may perform the determined actions, such as creating promotions for low-performing products, manually, and may only be able to do so on an intermittent, for example, weekly, basis. This can result in actions being taken by the merchant being less timely and less effective at leveraging the collected data to increase the performance of the online store.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example system suitable for management automation using database signals according to an implementation of the disclosed subject matter.

FIG. 2A shows an example arrangement suitable for management automation using database signals according to an implementation of the disclosed subject matter.

FIG. 2B shows an example arrangement suitable for management automation using database signals according to an implementation of the disclosed subject matter.

FIG. 3 shows an example procedure suitable for management automation using database signals according to an implementation of the disclosed subject matter.

FIG. 4 shows an example procedure suitable for management automation using database signals according to an implementation of the disclosed subject matter.

FIG. 5 shows an example procedure suitable for management automation using database signals according to an implementation of the disclosed subject matter.

FIG. 6 shows an example procedure suitable for management automation using database signals according to an implementation of the disclosed subject matter.

FIG. 7 shows a computer according to an implementation of the disclosed subject matter.

FIG. 8 shows a network configuration according to an implementation of the disclosed subject matter.

### DETAILED DESCRIPTION

Techniques disclosed herein enable management automation using database signals, which may allow for the management of an online store to be automated based on signals determined from data collected from the store. An API call requesting actionable signals may be sent to a service of a database. An API response including actionable signals may be received. The actionable signals may include indications of a subject and may be generated from performance metrics generated from data stored in the database. Subjects may be selected from the actionable signals. An API call including the selected subjects may be sent to a generative system. Generated items based on the selected subjects may be received from the generative system.

An API call requesting actionable signals may be sent to a service of a database. A database may store data generated by user interaction with a website, such as an online store. The data may include, for example, webpage impressions, user clicks on webpage hyperlinks, adding of items to a user’s cart, and purchasing of items. The database may store the data in any suitable format, including, for example, as a data lake object. An analysis system may use the data in the database to generate performance metrics, for example, in the form of key performance indicators (KPIs). The KPIs may be overall metrics for the performance of the website. For example, KPIs for an online store may include overall conversion rates for the online store, gross sales for the online store, and average order value for orders made from the online store. The analysis system may use the KPIs for a website to generate actionable signals for the website. The actionable signals may be slices or scopes of the KPIs that may provide a view of the data underlying a KPI. For example, actionable signals for an online store may include identification of the products that have the highest and lowest conversion rate, which may underly the KPI for overall conversion rate, identification of the worst performing products, which may underly the KPI for gross sales, and identification of the worst performing product category, which may underly the KPI for average order value. The database may include a service that may be interacted with through an application programming interface (API) that may allow access to the actionable signals. A request for the actionable signals for a specific website, for example, a specific online store, may be sent to the service of the database through an API call. The API call may be sent from, for example, a computing device that may be used by a party responsible for the website for which actionable signals were requested. The computing device may be part of a cloud computing server system that also includes the database. For example, the API call may be sent from a computing environment hosted on a computing device of a cloud computing server system that includes the database and that is used to host and manage the website for which the actionable signals are requested. The database may store data, KPIs, and actionable signals for multiple different websites, and a party sending an API call requesting actionable signals from the service of the database may only have permission to receive actionable signals or a website for which the party has permission to access data in the database. The API call may request specific actionable signals. For example, the API call may request actionable signals related to lower performing products and categories for an online store. The API call may be sent by, for example, an automated machine learning system agent running on the computing device, or may be sent by, for example, a machine learning system in response to input received from a user.

An API response including actionable signals may be received. The actionable signals may include indications of a subject and may be generated from performance metrics generated from data stored in the database. The service of the database may respond to the API call requesting actionable signals by sending actionable signals to the computing device from which the request was received. The actionable signals received in response to the API call may be selected based on any specific request included in the API call. For example, if the API call requests actionable signals related to lower performing products and categories for an online store, the received API response may include actionable signals that identify some number of the lowest performing products and product categories for that online store. The number of actionable signals included in the received API response may be, for example, based on the number of KPIs for the website for which the actionable signals were requested, for example, a specific number of actionable signals per KPI. The actionable signals for a KPI of overall conversion rate sent in response to an API call requesting actionable signals for lower performing products in an online store may identify some number of products in the online store that have the lowest conversion rates. The actionable signals may be generated from the performance metrics, for example, KPIs, in the database. Each actionable signal may include an indication of a subject, which may be, for example, the product or product category identified by the actionable signal.

Subjects may be selected from the actionable signals. After receiving the actionable signals in the API response, the subjects of some number of the actionable signals may be selected. For example, if the API response includes actionable signals related to lower performing products and categories for an online store, the subjects of the five actionable signals with the lowest performance level for each KPI for products for that online store may be selected, and the subject of the actionable signal with the lowest performance level for each KPI for product categories for that online store may be selected. The selection may be performed by, for example, an automated machine learning system agent running on the computing device, or by, for example, a machine learning system in response to input received from a user.

An API call including the selected subjects may be sent to a generative system. A generative system may be implemented using generative adversarial networks (GANs), generative pre-trained transformers (GPTs) or in any other suitable manner. The generative system may be implemented on the same cloud computing server system as the database. The API call sent to the generative system may include the subjects that were selected from the actionable signals received in the API response. For example, if five products that were the subject of received actionable signals were selected, the API call to the generative system may include an identification of those five products, or if a single product category that was the subject of a received actionable signal was selected, the API call to the generative system may include an identification of that single product category. Any number of API calls may be made to the generative system. For example, a single API call to the generative system may be made for each KPI for which actionable signals were received in an API response, with an API call made for a KPI including all of the subjects that were selected from the actionable signals for that KPI. An API call to the generative system may request that the generative system generate items based on the subjects in the API call. The generated items may be content items, such as, for example, product promotions. The API call may be sent from, for example, the computing device that may be used by the party responsible for the website for which actionable signals were requested. The API call may be sent by, for example, the automated machine learning system agent running on the computing device, or may be sent by, for example, a machine learning system in response to input received from a user.

Generated items based on the selected subjects may be received from the generative system. The generative system may generate items, for example, content items such as promotions, based on the subjects included in the API call. An API response from the generative system that includes the generated items may be received at the computing device which sent the API call to the generative system. The generated items may be used in any suitable manner. For example, if the generated items are promotions for products or product categories, the promotions may be reviewed by a user who manages the online store for which the promotions were generated. The user may choose whether to activate the promotions for the online store and may also make changes to the promotions. In some implementations, the generated items may be input to the automated machine learning system agent which may be able to determine how to use the generated items, for example, whether or not to activate promotions for an online store, without input from a user.

The generative system may operate within constraints set by a user. For example, when the generative system is used to generate promotions for an online store based on identified low-performing products and product categories, a user responsible for managing the online store may set up constraints on the promotions that are generated, such as limiting the amount of time a promotion may run for, limiting the number of times the promotion may be used on a store-wide, product-wide, or individual purchaser basis, and limiting the size of the price discount a promotion may offer. This may prevent the generative system from generating promotions that the user responsible for managing the online store may not want to activate.

The automated machine learning system may send API calls to the service of the database to obtain actionable signals, select subjects from the actionable signals, send API calls including the selected subjects to the generative system to obtain generated items such as promotions, and make use of the generated items without user intervention and at set intervals or on the occurrence of specified events. This may allow, for example, the automated machine learning system to automate the management of an online store using the actionable signals from performance metrics such as KPIs generated from data in the database for the online store. The automated machine learning system may determine low-performing products and product categories from on the actionable signals received in response to API calls to the service of the database, use API calls to the generative system to have promotions generated for the low-performing products and product categories, and automatically activate the promotions if the user responsible for managing the online store has already given the automated machine learning system permission to do so without requiring user approval.

The automated machine learning system may take other actions based on the subjects selected from the actionable signals. For example, the automated machine learning system may attempt to boost where low-performing products and product categories show up in search results through any suitable forms of search engine optimization.

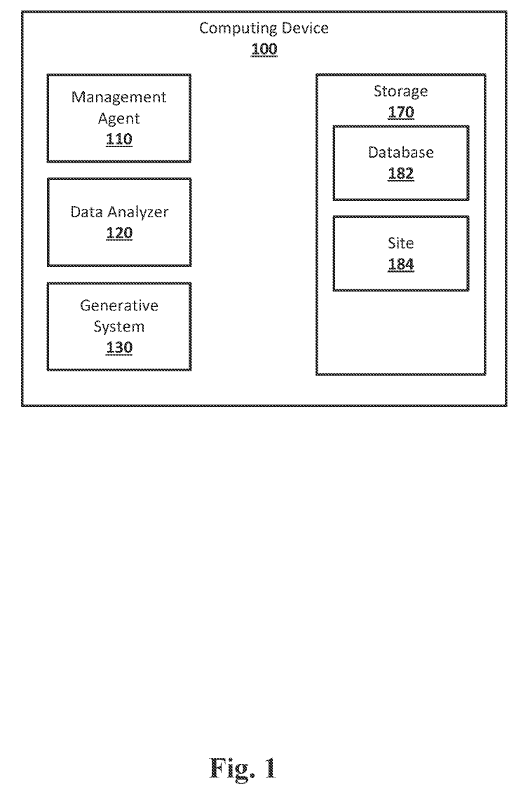

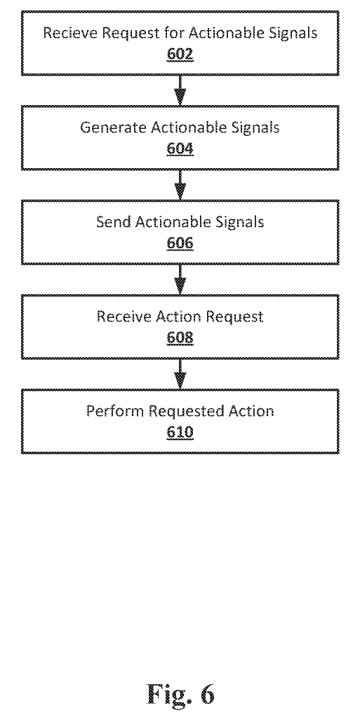

FIG. 1 shows an example system suitable for management automation using database signals according to an implementation of the disclosed subject matter. A computing device 100 may be any suitable computing device, such as, for example, a computer 20 as described in FIG. 7, or component thereof, for implementing management automation using database signals. The computing device 100 may be a single computing device, or may include multiple connected computing devices, and may be, for example, a laptop, a desktop, an individual server, a server cluster, a server farm, or a distributed server system, or may be a virtual computing device or system, or any suitable combination of physical and virtual systems. The computing device 100 may be part of a computing system and network infrastructure, or may be otherwise connected to the computing system and network infrastructure, including a larger server network which may include other server systems similar to the computing device 100. The computing device 100 may include any suitable combination of central processing units (CPUs), graphical processing units (GPUs), and tensor processing units (TPUs). For example, the computing device 100 may be, or be part of, a cloud computing sever system that may be a multi-tenanted server system.

The computing device 100 may include a management agent 110. The management agent 110 may be any suitable combination of hardware and software of the computing device 100 for implementing an automated machine learning system agent may manage an online site. The management agent 110 may, for example, send API calls to a service of database requesting actionable signals, identify subjects from the actionable signals, send an API call including identified subjects to a generative system, receive generated items from the generative system, and approve the generated items. The management agent 110 may manage an online site such as an online store. The generated items may be promotions for the online store, and the management agent 110 may, through approving the promotions, activate the promotions for the online store. The management agent 110 may run on the computing device 100 without requiring user input, allowing the management agent 110 to manage automate the management of the online site that the management agent 110 manages. The management agent 110 may be implemented in any suitable manner, using any suitable machine learning system.

The computing device 100 may include a data analyzer 120. The data analyzer 120 may be any suitable combination of hardware and software of the computing device 100 for performing data analysis on data from a database and implementing a service allowing for the results of the data analysis to be requested. The data analyzer 120 may, for example, perform data analysis on data for an online site, such as online store, to determine perform metrics, such as KPIs, and actionable signals, for the online site. The data analyzer 120 may be a service of a database and may include APIs that may be used to interact with the data analyzer 120 so that other processes, such as the management agent 110, may request data from the data analyzer 120.

The computing device 100 may include a generative system 130. The generative system 130 may be any suitable combination of hardware and software of the computing device 100 for generating items. The generative system 130 may, for example, be implemented using generative adversarial networks (GANs), generative pre-trained transformers (GPTs) or in any other suitable manner. The generative system 130 may generate items that may be related to the input to the generative system 130. For example, the generative system 130 may generate promotions based on input that identifies products or product categories for which promotions should be generated. The generated promotions may be generated to be used with an online site, for example, online store, that is managed by the management agent 110. The generative system 130 may include APIs that may be used to interact with the generative system 130. The generative system 130 may allow users to set guardrails or constraints on the generated items so that, for example, a user responsible for an online store may set constraints on the promotions that the generative system 130 generates for that online store in response to requests from the management agent 110. This may allow the management agent 110 to use the generative system 130 without additional user intervention while preventing undesirable promotions from being generated.

The storage 170 may be any suitable combination of hardware and software for storing data. The storage 170 may include any suitable combination of volatile and non-volatile storage hardware and may include components of the computing device 100 and hardware accessible to the computing device 100, for example, through wired and wireless direct or network connections. The storage 170 may store a database 182 and a site 184. The database 182 may be any suitable database that may store data for online sites, such as online stores. The site 184 may be, for example, an online site, such as an online store. The site 184 may be, for example, in the form of a website, or may be the server-side of an application accessible with a client application run on client computing devices.

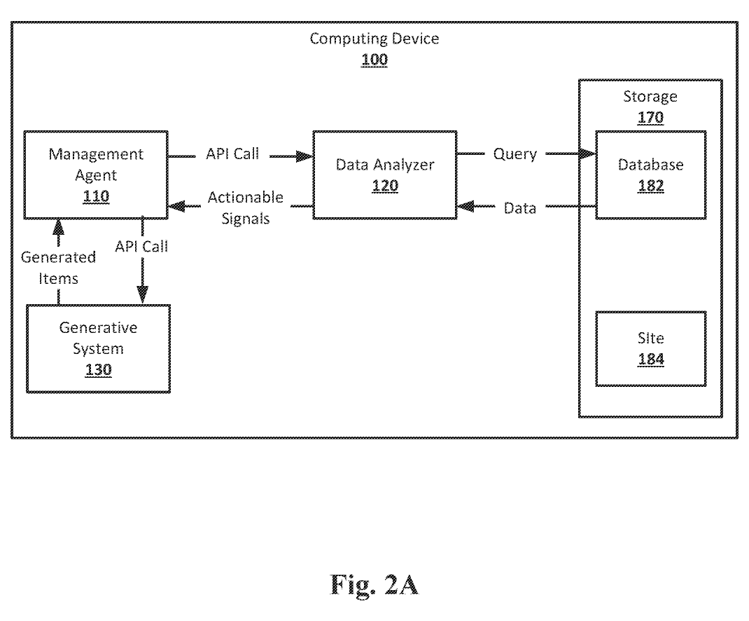

FIG. 2A shows an example arrangement suitable for management automation using database signals according to an implementation of the disclosed subject matter. The management agent 110 may send an API call to the data analyzer 120 requesting actionable signals. The management agent 110 may send the API call to the data analyzer 120 at any suitable time, including, for example, at set intervals or on the occurrence of specified events. The API call may request actionable signals for the site 184 which may be managed by the management agent 110.

The data analyzer 120 may query the database 182 for data for the site 184. The database 182 may store data for the site 184, which may be an online store. The data stored for the site 184 in the database 182 may include, for example, data generated by user interaction with the site 182, including, webpage impressions, user clicks on webpage hyperlinks, adding of items to a user’s cart, and purchasing of items. The database 182 may store the data in any suitable format, including, for example, as a data lake object. The data analyzer 120 may use the data for the site 184 from the database 182 to generate performance metrics, such as KPIs The KPIs may be overall metrics for the performance of the site 184, which may be an online store, including overall conversion rates for the online store, gross sales for the online store, and average order value for orders made from the online store. The data analyzer 120 may use the KPIs generated for the site 184 to generate actionable signals for the site 184. The actionable signals may be slices or scopes of the KPIs that may provide a view of the data underlying a KPI. For example, actionable signals for the site 184 may include identification of the products that have the highest and lowest conversion rate, which may underly the KPI for overall conversion rate, identification of the worst performing products, which may underly the KPI for gross sales, and identification of the worst performing product category, which may underly the KPI for average order value.

The actionable signals may be returned by the data analyzer 120 to the management agent 110. The actionable signals may be returned, for example, via an API response sent from the data analyzer 120 to the management agent 110. The actionable signals may include indications of a subject. The actionable signals received in response to the API call may be selected based on any specific request included in the API call. For example, if the API call requests actionable signals related to lower performing products and categories for the site 184, the received API response may include actionable signals that identify some number of the lowest performing products and product categories for the site 184. The number of actionable signals included in the received API response may be, for example, based on the number of KPIs for the site 184 for which the management agent 110 requested actionable signals, for example, a specific number of actionable signals per KPI. The actionable signals for a KPI of overall conversion rate sent in response to an API call requesting actionable signals for lower performing products in the site 184 may identify some number of products in the online store of the stie 184 that have the lowest conversion rates. Each actionable signal may include an indication of a subject, which may be, for example, the product or product category identified by the actionable signal.

The management agent 110 may select subjects from the received actionable signals. After receiving the actionable signals in the API response, the management agent 110 may select the subjects of some number of the actionable signals. For example, if the API response includes actionable signals related to lower performing products and categories for the site 184, the management agent 110 may select the subjects of the five actionable signals with the lowest performance level for each KPI for products for the site 184 and may also select the subject of the actionable signal with the lowest performance level for each KPI for product categories for the site 184.

The management agent 110 may send an API call to the generative system 130 identifying the selected subjects and requesting that the generative system 130 generate items based on the selected subjects. The management agent 110 may send the API call to the generative system 130 after selecting subjects from the actionable signals received from the data analyzer 120. For example, if five products that were the subject of received actionable signals were selected by the management agent 110, the API call to the generative system 130 may include an identification of those five products, or if a single product category that was the subject of a received actionable signal was selected, the API call to the generative system 130 may include an identification of that single product category. The management agent 110 may make any number of API calls to the generative system. For example, the management agent 110 may make a single API call to the generative system 130 for each KPI for which actionable signals were received in an API response from the data analyzer 120, with an API call made for a KPI including all of the subjects that were selected from the actionable signals for that KPI. An API call to the generative system 130 may request that the generative system 130 generate items based on the subjects in the API call. The generated items may be content items, such as, for example, product promotions that may be used on the site 184.

The generative system 130 may generate and send generated items to the management agent 110 in response to API calls received from the management agent 110. The generated items may be, for example, promotions for products and product categories sold on the site 184 that were the subjects of actionable signals received by the management agent 110 from the data analyzer 120 and were subsequently selected by the management agent 110 and included in an API call sent to the generative system 130. For example, the API call from the management agent 110 to the generative system 130 may include as selected subjects the five lowest performing products for a gross sales KPI from the site 184. The generative system 130 may generate promotions for these five products. The promotions may be generated in any suitable manner and may include any suitable data that may be used to implement the promotions on the site 184, including, for example, discount percentages, promotion eligibility, promotion lengths, and limits on how many times promotions may be used by a single party or overall. The promotions may be generated in the form of records that may be usable to activate the promotions on the site 184. The generative system 130 may operate within guardrails or constraints set by a user responsible for the site 184. For example, when the generative system 130 is used to generate promotions for low-performing products and product categories from the site 184, a user responsible for managing the site 184 may set up constraints on the promotions that are generated, such as limiting the amount of time a promotion may run for, limiting the number of times the promotion may be used on a store-wide, product-wide, or individual purchaser basis, and limiting the size of the price discount a promotion may offer.

FIG. 2B shows an example arrangement suitable for management automation using database signals according to an implementation of the disclosed subject matter. The management agent 110 may approve the generated items from the generative system 130 and activate the generated items on the site 184. For example, the generated items may be promotions for products and product categories sold on the site 184. The management agent 110 may approve the promotions and activate the promotions on the site 184. The management agent 110 may approve the promotions without intervention from a user or may request approval from a user responsible for the site 184. The management agent 110 may activate the promotions by, for example, inserting records for the promotions to an appropriate database for the site 184, for example, the database 182. This may cause the promotions to become active on the site 184, allowing users to access and use the promotions when purchasing products from the site 184. The promotions may also be accessible to other systems associated with the site 184, for example, customer relationship systems that may send electronic communications to customers notifying them of the promotions that have been activated on the site 184.

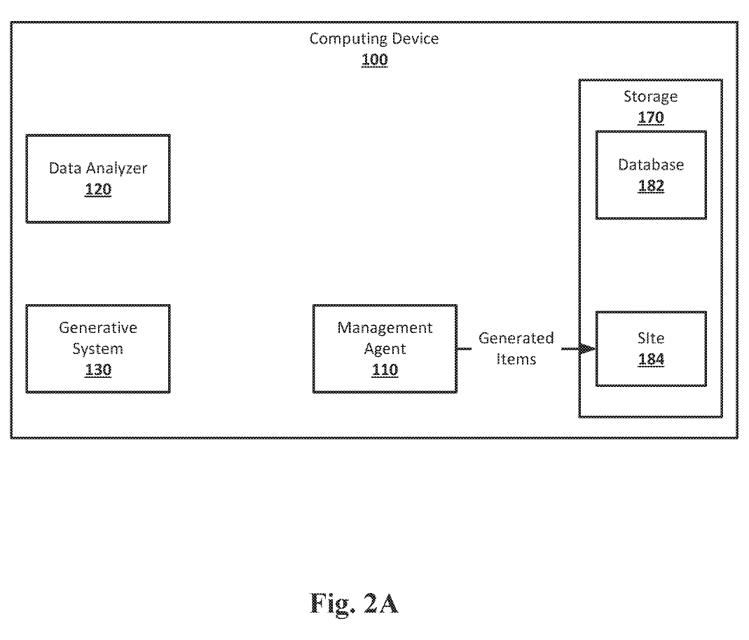

FIG. 3 shows an example procedure suitable for management automation using database signals according to an implementation of the disclosed subject matter. At 302, a request for actionable signals may be sent. For example, the management agent 110 may send, through an API call, a request to the data analyzer 120 for actionable signals for the site 184 which may be managed by the management agent 110. The management agent 110 may send the request for actionable signals at any suitable time, for example, at set intervals or based on the occurrence of specified events. The management agent 110 may send the request without user prompting or intervention.

At 304, actionable signals may be received. For example, the management agent 110 may receive a response, such as an API response, to the request for actionable signals sent to the data analyzer 120. The response may include actionable signals generated by the data analyzer 120. The actionable signals may identify subjects. For example, the actionable signals may include an identification of a number of low performing products or product categories per performance metric, or KPI, for the site 184. For example, an actionable signal may identify products sold on the site 184 that have the lowest conversion rates. The management agent 110 may receive any number of actionable signals from the data analyzer 120. For example, if the data for the site 184 is used to generate three performance metrics for products and two performance metrics for product categories, the data analyzer 120 may send actionable signals identifying the lowest performing products across the three performance metrics for products and the two performance metrics for product categories.

At 306, subjects may be selected from the actionable signals. For example, the management agent 110 may select subjects, for example, products, from among the subjects identified in the actionable signals. An actionable signal may, for example, identify ten of the lowest performance products for a performance metric for the site 184. The management agent 110 may select five of those products from the actionable signal. The management agent 110 may select any suitable number of subjects from actionable signals, and may select different numbers of subjects from different actionable signals. For example, the management agent 110 may select five products from actionable signals that identify low performing products and may select one product category from actionable signals that identify product categories.

At 308, a request for generated items based on the selected subject may be sent. For example, the management agent 110 may send the selected subjects, for example, products and product categories, to the generative system 130 in an API call requesting that the generative system 130 generate items, for example, promotions, based on the selected subjects. The management agent 110 may send any number of selected subjects to the generative system 130.

At 310, generated items may be received. For example, the management agent 110 may receive items generated by the generative system 130 in response to the request sent by the management agent 110. The generated items may be, for example, promotions for the products and product categories included in the request sent by the management agent 110. The generated items may be in any suitable format. For example, promotions may be in the form of records that may be used to activate the promotions on the site 184 through insertion into an appropriate database, such as the database 182.

At 312, the generated items may be used. For example, the management agent 110 may use the generated items received from the generative system 130 in any suitable manner. The management agent 110 may, for example, approve and activate on the site 184 any promotions received from the generative system 130. The management agent 110 may activate received promotions for the site 184 by, for example, inserting records for the promotions in an appropriate database, or in any other suitable manner. The management agent 110 may also use generated items by requesting approval of the generated items. For example, the management agent 110 may notify a user responsible for the site 184 of any promotions received by the management agent 110 from the generative system 130 so that the user may review and approve the promotions. Upon approval from the user, the management agent 110 may activate any approved promotions.

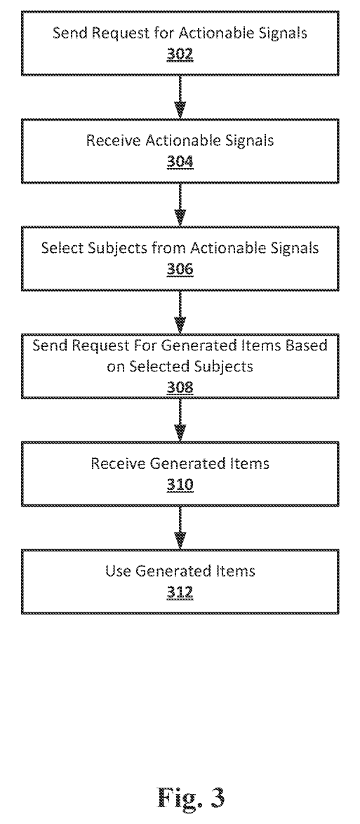

FIG. 4 shows an example procedure suitable for management automation using database signals according to an implementation of the disclosed subject matter. At 402, a request for actionable signals may be received. For example, the database analyzer 120 may receive a request for actionable signals from the management agent 110. The request may be for actionable signals for a site, such as an online store, that the management agent 110 is responsible for managing, for example, the site 184.

At 404, a database may be queried for data. For example, the data analyzer 120 may query the database 182 for data from the site 184 that may be used to generate actionable signals. The queried data may be, for example, data used to generate performance metrics for products and product categories sold by the site 184, such as sales data and conversion rate data.

At 406, actionable signals may be generated from the data. For example, the data analyzer 120 may determine from the data for site 184 the lowest performing products and products categories across various performance metrics for the site 184. The lowest performing products and product categories may be the subjects for actionable signals generated by the data analyzer 120.

At 408, the actionable signals may be sent. For example, the data analyzer 120 may send the generated actionable signals to the management agent 110. The actionable signals may include an identification of subjects of the actionable signals, for example, identification of products and product categories, along with the performance metrics the actionable signal is for what the actionable signal represents. For example, an actionable signal may be for the performance metric of conversion rate, may represent products with the lowest conversion rates, and may identify the products that have the lowest conversion rates for the site 184.

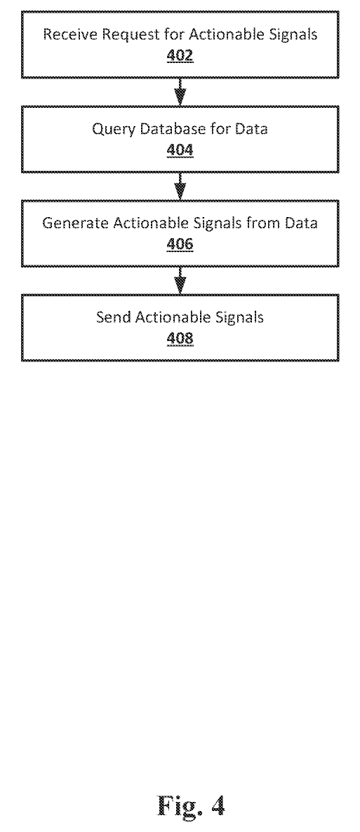

FIG. 5 shows an example procedure suitable for management automation using database signals according to an implementation of the disclosed subject matter. At 502, generated promotions may be received. For example, the management agent 110 may receive promotions for products and product categories generated by the generative system 130. The promotions may be received in any suitable format, such as, for example, as records.

At 504, if the promotions are approved, flow may proceed to 506. Otherwise, flow may proceed to 508. Promotions may be approved by the management agent 110 without intervention from a user. The management agent 110 may automatically approve received promotions, or may check received promotions against guidelines and constraints to ensure that the generative system 130 adhered to the guidelines and constraints when generating the promotions and may disapprove promotions that violate any guidelines or constraints. The management agent 110 may alternatively notify a user, for example, a user responsible for an online store such as the site 184 that the promotions were generated for, of the promotions so that the user may review and approve or disapprove the promotions.

At 506, the promotions may be activated. For example, the management agent 110 may activate approved promotions for the site 184 by inserting records for the promotions into the appropriate database, or otherwise interacting with any suitable interface for managing the site 184 in order to activate the promotions. The management agent 110 may activate promotions that were approved by the management agent 110 and promotions approved by the user responsible for the site 184.

At 508, promotions may be discarded. For example, the management agent 110 may discard any promotions that were disapproved, whether they were disapproved by the management agent 110 or by the user responsible for the site 184. This may ensure that promotions that violate any guidelines or constraints or were disapproved by the user responsible for the site 184 for any reason are not activated for the site 184 and cannot be used to purchase products from the site 184.

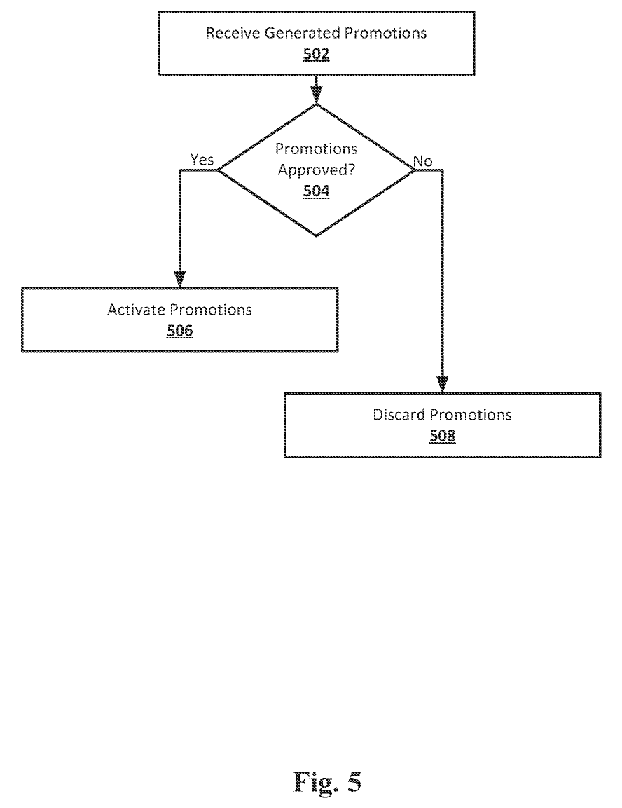

FIG. 6 shows an example procedure suitable for management automation using database signals according to an implementation of the disclosed subject matter. At 602, a request for actionable signals may be received. For example, the management agent 110 may receive a request for actionable signals from a user responsible for the site 184. The request may be received in any suitable manner, for example, through a user interface of the management agent 110. The request may be a general request for actionable signals for the site 184 or may specify any suitable conditions for the actionable signals, such as, for example, that the actionable signals should be generated for specified performance metrics.

At 604, actionable signals may be generated. For example, the management agent 110 may generate actionable signals in accordance with the request from the user by sending the request to the data analyzer 120. The data analyzer 120 may then generate and return actionable signals based on any conditions specified in the request sent to the management agent 110.

At 606, actionable signals may be sent. For example, the management agent 110 may send actionable signals to the user who requested the actionable signals. The actionable signals may be sent to the user in any suitable manner, such as through a user interface of the management agent 110 or through any other suitable type of electronic communication.

At 608, an action request may be received. For example, the management agent 110 may receive a request from the user responsible for the site 184 to take specific actions in relation to the actionable signals. The action request may, for example, be a request to generate promotions for any of the subjects, for example, products and product categories identified in the actionable signals, or a request to boost any of the subjects in search results. The action request may be received in any suitable manner, for example, through a user interface of the management agent 110.

At 610, the requested action may be performed. For example, the management agent 110 may perform suitable actions based on the received action request. The management agent 110 may, for example, use the generative system 110 to generate promotions for products and product categories included in an action request, or may perform any suitable search boosting actions to boost the appearance in search results of products and products included in an action request. Promotions generated in response to an action request may be sent by the management agent 110 to the user responsible for the site 184 for approval before being activated on the site 184.

Implementations of the presently disclosed subject matter may be implemented in and used with a variety of component and network architectures. FIG. 7 is an example computer 20 suitable for implementing implementations of the presently disclosed subject matter. As discussed in further detail herein, the computer 20 may be a single computer in a network of multiple computers. As shown in FIG. 7, computer may communicate a central component 30 (e.g., server, cloud server, database, etc.). The central component 30 may communicate with one or more other computers such as the second computer 31. According to this implementation, the information obtained to and/or from a central component 30 may be isolated for each computer such that computer 20 may not share information with computer 31. Alternatively or in addition, computer 20 may communicate directly with the second computer 31.

The computer (e.g., user computer, enterprise computer, etc.) 20 includes a bus 21 which interconnects major components of the computer 20, such as a central processor 24, a memory 27 (typically RAM, but which may also include ROM, flash RAM, or the like), an input/output controller 28, a user display 22, such as a display or touch screen via a display adapter, a user input interface 26, which may include one or more controllers and associated user input or devices such as a keyboard, mouse, WiFi/cellular radios, touchscreen, microphone/speakers and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 enable data communication between the central processor 24 and the memory 27, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 20 can be stored on and accessed via a computer readable medium, such as a hard disk drive (e.g., fixed storage 23), an optical drive, floppy disk, or other storage medium 25.

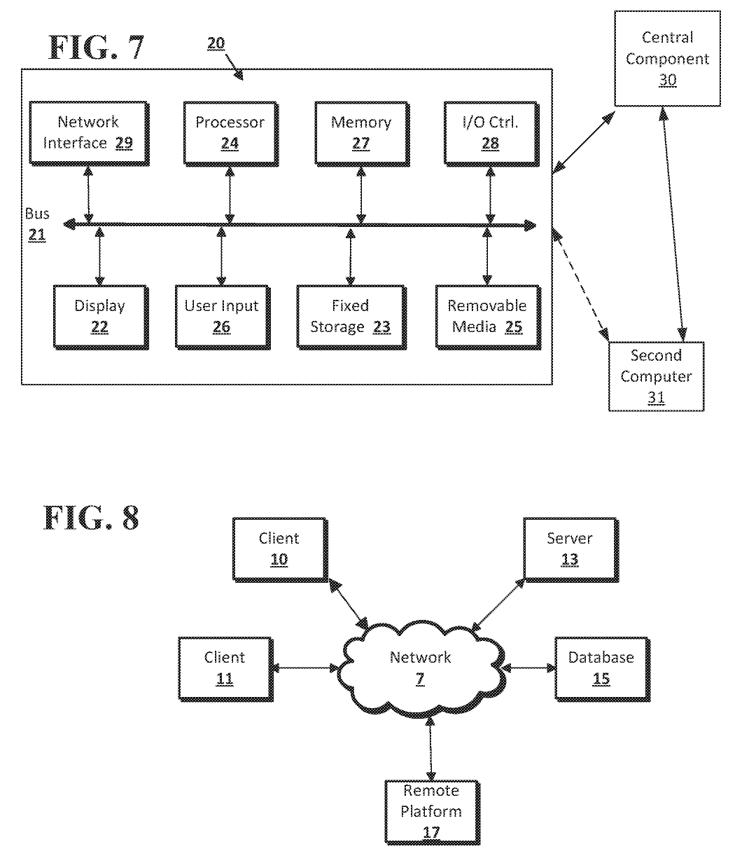

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may enable the computer to communicate with other computers via one or more local, wide-area, or other networks, as shown in FIG. 8.

Many other devices or components (not shown) may be connected in a similar manner (e.g., document scanners, digital cameras and so on). Conversely, all of the components shown in FIG. 7 need not be present to practice the present disclosure. The components can be interconnected in different ways from that shown. The operation of a computer such as that shown in FIG. 7 is readily known in the art and is not discussed in detail in this application. Code to implement the present disclosure can be stored in computer-readable storage media such as one or more of the memory 27, fixed storage 23, removable media 25, or on a remote storage location.

FIG. 8 shows an example network arrangement according to an implementation of the disclosed subject matter. One or more clients 10, 11, such as computers, microcomputers, local computers, smart phones, tablet computing devices, enterprise devices, and the like may connect to other devices via one or more networks 7 (e.g., a power distribution network). The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15. Information from or about a first client may be isolated to that client such that, for example, information about client 10 may not be shared with client 11. Alternatively, information from or about a first client may be anonymized prior to being shared with another client. For example, any client identification information about client 10 may be removed from information provided to client 11 that pertains to client 10.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A computer-implemented method comprising:
sending an API call requesting one or more actionable signals to a service of a database;
receiving an API response comprising the one or more actionable signals, wherein the one or more actionable signals comprise indications of a subject and are generated from one or more performance metrics generated from data stored in the database;
selecting, from the one or more actionable signals, one or more subjects;
sending an API call comprising the selected one or more subjects to a generative system; and
receiving, from the generative system, one or more generated items based on the selected one or more subjects.

2. The computer-implemented method of claim 1, wherein the data stored in the database comprises data for an online store, and wherein the subjects comprise products or product categories sold by the online store.

3. The computer-implemented method of claim 2, wherein the one or more generated items comprise promotions for the products of the one or more selected subjects, and further comprising:
activating the promotions for the one or more generated items in the online store.

4. The computer-implemented method of claim 3, wherein activating the promotions for the one or more generated items in the online store further comprises inserting records for the promotions into a database used by the online store.

5. The computer-implemented method of claim 3, further comprising before activating the promotions, approving the promotions without user input.

6. The computer-implemented method of claim 5, wherein approving the promotions without user input further comprises determining that the promotions do not violate constraints for promotions for the online store.

7. The computer-implemented method of claim 1, further comprising performing one or more actions to boost the appearance of the one or more subjects in search results.

8. A computer-implemented system comprising:
one or more storage devices; and
a processor that sends an API call requesting one or more actionable signals to a service of a database,
receives an API response comprising the one or more actionable signals, wherein the one or more actionable signals comprise indications of a subject and are generated from one or more performance metrics generated from data stored in the database,
selects, from the one or more actionable signals, one or more subjects,
sends an API call comprising the selected one or more subjects to a generative system, and
receives from the generative system, one or more generated items based on the selected one or more subjects.

9. The computer-implemented system of claim 8, wherein the data stored in the database comprises data for an online store, and wherein the subjects comprise products or product categories sold by the online store.

10. The computer-implemented system of claim 9, wherein the one or more generated items comprise promotions for the products of the one or more selected subjects, and wherein the processor further activates the promotions for the one or more generated items in the online store.

11. The computer-implemented system of claim 10, wherein the processor activates the promotions for the one or more generated items in the online store further by inserting records for the promotions into a database used by the online store.

12. The computer-implemented system of claim 10, wherein the processor, before activating the promotions, approves the promotions without user input.

13. The computer-implemented system of claim 12, wherein the processor approves the promotions without user input by determining that the promotions do not violate constraints for promotions for the online store.

14. The computer-implemented system of claim 8, wherein the processor further performs one or more actions to boost the appearance of the one or more subjects in search results.

15. A system comprising: one or more computers and one or more non-transitory storage devices storing instructions which are operable, when executed by the one or more computers, to cause the one or more computers to perform operations comprising:
sending an API call requesting one or more actionable signals to a service of a database;
receiving an API response comprising the one or more actionable signals, wherein the one or more actionable signals comprise indications of a subject and are generated from one or more performance metrics generated from data stored in the database;
selecting, from the one or more actionable signals, one or more subjects;
sending an API call comprising the selected one or more subjects to a generative system; and
receiving, from the generative system, one or more generated items based on the selected one or more subjects.

16. The system of claim 15, wherein the data stored in the database comprises data for an online store, and wherein the subjects comprise products or product categories sold by the online store.

17. The system of claim 16, wherein the one or more generated items comprise promotions for the products of the one or more selected subjects, and wherein the instructions which are operable, when executed by the one or more computers, to cause the one or more computers to perform operations comprising activating the promotions for the one or more generated items in the online store.

18. The system of claim 17, wherein the instructions which are operable, when executed by the one or more computers, to cause the one or more computers to perform operations comprising activating the promotions for the one or more generated items in the online store further cause the one or more computers to perform operations comprising inserting records for the promotions into a database used by the online store.

19. The system of claim 17, wherein the one or more generated items comprise promotions for the products of the one or more selected subjects, and wherein the instructions which are operable, when executed by the one or more computers, to cause the one or more computers to perform operations comprising, before activating the promotions, approving the promotions without user input.

20. The system of claim 19, wherein the instructions which are operable, when executed by the one or more computers, to cause the one or more computers to perform operations comprising approving the promotions without user input further cause the one or more computers to perform operations comprising determining that the promotions do not violate constraints for promotions for the online store.
